(19) United States
(12) Patent Application Publication
(10) Pub. No.: US 2023/0160676 A1
(43) Pub. Date: May 25, 2023

(54) GAGE ASSEMBLY

(71) Applicant: Terry Bush, Marne, MI (US)

(72) Inventor: Terry Bush, Marne, MI (US)

(21) Appl. No.: 18/058,552

(22) Filed: Nov. 23, 2022

Related U.S. Application Data
(60) Provisional application No. 63/282,756, filed on Nov. 24, 2021.

(51) Int. Cl. G01B 3/20

(52) U.S. Cl. CPC G01B 3/20

(57) ABSTRACT

A gage assembly includes a base having an arm configured to move between an open position and a closed position and a clamp fixed to the base. The clamp includes a handle configured to move between a first position and a second position. The clamp also includes a clamp extension configured to move between an open position and a closed position. The movement of the handle corresponds with movement of the clamp extension between the first position and the second position and of the arm between the open position and the closed position such that when the handle is in the first position the arm and the clamp extension are in the open position and when the handle is in the second position the arm and the clamp extension are in the closed position.

### CROSS-REFERENCE TO RELATED APPLICATION

This application claims priority under 35 U.S.C § 119(e) to U.S. Provisional Patent Application No. 63/282,756, filed Nov. 24, 2021, the disclosure of this prior application is considered part of this application and is hereby incorporated by reference in its entirety.

### TECHNICAL FIELD

The present disclosure relates generally to check fixtures and gages configured to check various features of a product, such as gage assemblies, subassemblies, and components thereof.

### BACKGROUND

Check fixtures are commonly used to check high volume production parts or products for dimensional accuracy and consistency by inserting the part or product into the fixture and locating touch points against surfaces of the part or product. While known check fixtures have proven to be acceptable for various applications, such gage assemblies, subassemblies and components thereof are nevertheless susceptible to improvements that may enhance their overall performance and cost. Therefore, a need exists for gage assemblies, subassemblies, and components thereof that advance the art.

### SUMMARY

The present disclosure provides a gage assembly that includes a base having an arm that is configured to move between an open position and a closed position. The gage assembly also includes a clamp that is fixed to the base. The clamp includes a handle configured to move between a first position and a second position. The clamp also includes a clamp extension configured to move between an open position and a closed position. The arm and the clamp extension are configured to move in response to movement of the handle.

Implementations of the disclosure may include one or more of the following optional features. In some examples, movement of the handle from the first position to the second position corresponds with movement of the clamp extension from the closed position to the open position. Also, in some examples, movement of the handle from the first position to the second position corresponds with movement of the arm from the closed position to the open position. The arm and the clamp extension, in some implementations, are in the closed position when the handle is the first position. In some implementations, the arm and the clamp extension are in the open position when the handle is the second position.

In some examples, movement of the handle toward the second position corresponds with simultaneous movement of the clamp extension toward the open position and movement of the arm toward the open position. Movement of the handle between the first position and the second position may correspond with movement of the clamp extension and of the arm between the open position and the closed position, such that when the handle is in the first position the arm and the clamp extension are in the open position and when the handle is in the second position the arm and the clamp extension are in the closed position.

In some examples, the clamp is a vertical hold down clamp. In another example, the gage assembly the clamp is a horizontal hold down clamp. In another example, the clamp is a vertical manual toggle clamp. In yet another example, the clamp is a horizontal manual toggle clamp.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is perspective view of one example of a gage assembly;

FIG. 2 is a top view of the gage assembly shown in FIG. 1;

FIG. 3 is a side view of the gage assembly shown in FIG. 1;

FIG. 4 is a bottom view of the gage assembly shown in FIG. 1;

FIG. 5 is a perspective environmental view of another example of a gage assembly;

FIG. 6 is another perspective environmental view of multiple gage assemblies shown in FIG. 5;

FIG. 7 is a perspective environmental view of another example of a gage assembly;

FIG. 8 is another perspective environment view of the gage assembly shown in FIG. 5;

FIG. 9A is a perspective view of another example of a gage assembly;

FIG. 9B is a perspective view of another example of a gage assembly;

FIG. 9C is a perspective view of another example of a gage assembly;

FIG. 9D is a perspective view of another example of a gage assembly;

FIG. 9E is a perspective view of another example of a gage assembly;

FIG. 9F is a perspective view of another example of a gage assembly;

FIG. 9G is a perspective view of another example of a gage assembly;

FIG. 9H is a perspective view of another example of a gage assembly;

FIG. 9I is a perspective view of another example of a gage assembly;

FIG. 10 is perspective view of another example of a gage assembly;

FIG. 11 is a top view of a base of the gage assembly shown in FIG. 10;

FIG. 12 is a side view of the base of the gage assembly shown in FIG. 10;

FIG. 13 is a bottom view of the base of the gage assembly shown in FIG. 10;

FIG. 14 is a perspective environmental view the gage assembly shown in FIG. 1 and another example of the gage assembly; and

FIGS. 15-18 are perspective environmental views of the example of multiple gage assemblies shown in FIG. 1 in operation.

Like reference symbols in the various drawings indicate like elements.

### DETAILED DESCRIPTION

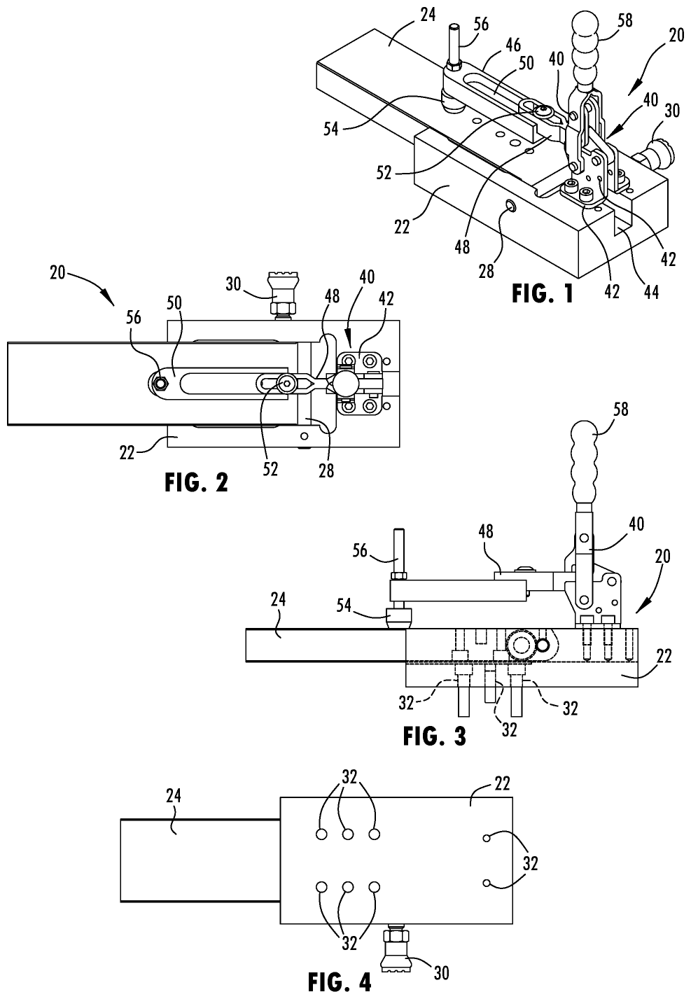

Referring to the examples shown in FIGS. 1-8, the gage assembly 20 includes a base 22 having an arm 24. In some examples, the arm 24 is movably coupled to the base 22 and configured to move between an open position and a closed position. More specifically, the base 22 may be a generally rectangular block and is comprised of steel, aluminum, wood, or the like to provide a sturdy and stable foundation for the operation of the gage assembly 20. However, various other shapes of bases 22 have been contemplated, as described in more detail below. In the example shown in FIGS. 1-8, the base 22 has a recessed portion 26 configured to allow the arm 24 to receive and support the arm. The recessed portion 26 has a depth equal to the thickness of the arm 24, so that when the arm 24 is in the closed position the top surface of the base 22 is generally aligned with the top surface of the arm 24 thereby proving a smooth continuous surface.

In moving the arm to the open position, such as to allow a part or product to be removed or inserted, the arm 24 may rotate relative to the base 22. For example, such as shown in FIG. 1, the base 22 may include a pin, such as a bolt 28, which is configured to couple the arm 24 to the remainder of the base 22. The pin may couple the arm 24 and the base 22 and provide a pivot point for the arm 24 to move between the open position and the closed position. For example, a threaded portion of the bolt 28 may engage a threaded opening in the base 22 and the arm 24 may rotates relative to the base 22 about an unthreaded portion of the bolt 28, which spans across the recessed portion 26 of the base 22. As shown in FIGS. 1-4, the arm 24 may pivot about the bolt 28 upward away from the recessed portion 26 of the base 22 toward the open position. In the example shown in FIGS. 2 and 3, a space is present between the proximal end of the arm 24 and the base 22 to allow for movement of the proximal end of the arm upon rotation of the arm 24 about the bolt 28 within the recessed portion 26 of the base 22. It is also contemplated that the base 22 may include a lockout feature 30. The lockout feature 30 may be spring loaded and configured to lock the arm 24 in the desired position, such as in the open position, the closed position, or there between, and prevent undesired movement thereof. The lockout feature 30 may be coupled directly to the bolt 28 or may be a separate component configured to secure the arm 24 in the desired position.

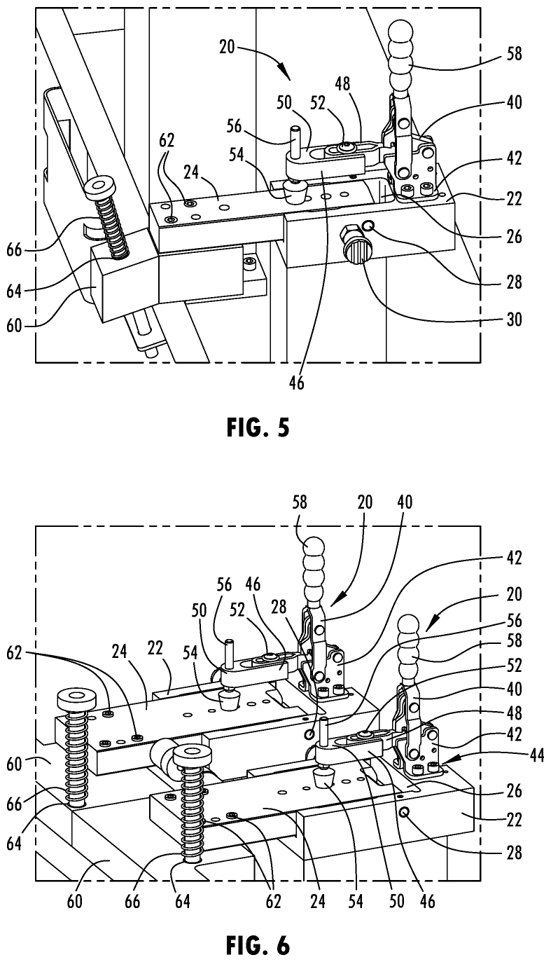

As shown in FIGS. 3 and 4, an underside of the base 22 may include one or more apertures configured to have one or more screws or dowels that are conjured to pass through the apertures. The screws and/or dowels may be configured to be attached to another surface such as a checking table, stand, cart, or the like to secure the base 22 and prevent undesired movement. The base 22 may also include a bolt aperture configured to allow the bolt 28 to be disposed there through. In the example shown, the arm 24 is a generally rectangular prism and extends past the base 22, such that the arm 24 may be configured to be coupled to the product and/or an additional clamping system that secures the product, as shown in FIG. 5. The arm 24 may include any number of apertures as desired to allow for this attachment or attachment to other portions of the gage assembly 20.

Referring still to the example shown in FIGS. 1-4, a clamp 40 is fixed to a platform portion of the base 22 adjacent to the recessed portion 26. The clamp 40 may include a tap portion 42 which is configured to be fixed to the base 22 and extend upwards therefrom. In one example, the tap is secured to the base 22 by fasteners disposed through the tap and into the top surface of the platform portion of the base 22. In some examples, the tap portion 42 includes four fasteners disposed there through and into the platform portion of the base 22. Moreover, as illustrated in FIG. 1, one pair of the fasteners may be separated by a second recessed portion 44 in the base 22, such that one pair of fasteners is disposed on one side of the recessed portion 26 and the other pair of fasteners is disposed on the opposite side of the recessed portion 26. In the example shown in FIGS. 1-4, the second recessed portion 44 extends from the proximal end of the first recessed portion 26 in the same horizontal direction as the first recessed portion 26. However, the second recessed portion 44 has a smaller lateral width relative to the first recessed portion 26, such that the tap portion 42 can be fixed to the surfaces adjacent to and on opposing lateral sides of the second recessed portion 44. However, in some configurations, such as described below, the second recessed portion is not present on the base. Additionally, various other configurations of the recessed portion are contemplated based on the size and shape of the desired clamp to be fixed to the base.

In the example shown in FIGS. 1-4, the tap is movably coupled to a clamp extension 46 which extends perpendicularly from the tap. The clamp extension 46 is configured to move between an open position and a closed position and the clamp extension 46 has a length which extends parallel to and is spaced from the arm 24 when the clamp extension 46 is in the closed position. When the clamp extension 46 is in the open position, the clamp extension 46 rotates about the tap portion 42 such that the clamp extension 46 rotates in a similar manner and direction as described above with respect to the arm 24 of the base 22. For example, as shown in FIGS. 1-4, the clap extension rotates about an axis that is parallel to the rotational axis of the arm 24. In some examples, movement of the clamp extension 46 actuates movement of the arm 24 such that the clamp extension 46 rotates between the open position and the closed position in conjunction with the rotation of the arm 24 between the open position and the closed position. However, it is also contemplated that the clamp extension 46 may move independently between the open position and the closed position, i.e. without actuating any movement of the arm 24.

The clamp extension 46 and tap may be comprised of metal such as steel, stainless steel, aluminum, or another strong material to secure the clamp 40 and the base 22 and also secure the product to be checked. The clamp extension 46 may also include a proximal swing portion 48 and a distal swing portion 50, where the proximal swing portion 48 is fixed to the tap such that the proximal swing portion 48 is rotatable between the closed position and the open position but is unable to be adjusted or otherwise move linearly. The distal swing portion 50 is releasable secured to the proximal swing portion and longitudinally movable relative to the proximal swing portion in the direction between the proximal end of the arm 24 and the distal end of the arm 24, such that the distal swing portion is configured to be secured at a plurality of locations along the proximal swing portion to lengthen or shorten the overall length of the clamp extension 46. In the example shown, the proximal swing portion 48 and the distal swing portion 50 may be a coupled using a screw 52 extended, such that the proximal swing portion 48 is coupled to the tap and the proximal swing portion 48 and the distal swing portion 50 are coupled to one another with a screw there between. The screw may be loosened such that the distal swing portion 50 may be linearly moved fore and aft in order to shorten or lengthen the length of the clamp extension 46. Once the clamp extension 46 is at the desired length, the screw may once again be tightened such that the first portion and the second portion are not moveable relative to one another. The clamp extension 46 allows for customizable length of the clamp extension 46 such that a variety of parts may be checked by a single base 22 and arm 24 combination. The distal swing portion 50 may also include channels disposed on opposite sides of the distal swing portion 50 and configured to engage the proximal swing portion 48 and allow the movement between lengths.

The clamp extension 46 also includes a clamp engager 54 that is coupled at the distal end of the distal swing portion 50 and extends downward, perpendicular to the length of the clamp extension 46. In the example shown, the distal swing portion 50 includes an aperture disposed near the distal end such that the clamp engager 54 may be disposed there through. Moreover, in the example shown, the clamp engager 54 has a pin portion 56 extending through the aperture and towards the arm 24 and a flexible portion disposed at the distal end of the pin portion 56. The pin portion 56 extends towards the arm 24 from the distal swing portion 50. In one example, the pin portion 56 may be threaded, such as a bolt or screw, which allows the length of the pin portion 56 to be easily adjusted by a user. However, other examples and configurations have fixed length pin portions 56. Moreover, the flexible portion is disposed about the distal end of the pin may be comprised of a rubber, polymer, or other soft material, which can engage one or more of the arm 24 and/or the part or product to be checked and lock the arm 24 in the closed position and/or secure the part or product between the flexible portion and another component without damage or indentation of the arm 24 and/or the part or product to be checked.

Referring still to FIGS. 1-4, the gage assembly 20 also includes a handle 58 coupled to the clamp extension 46. The handle 58 is shaped and sized to allow a user to engage the handle 58 with one hand and to move the handle 58 between a first position, corresponding with the one or more of the arm 24 of the base 22 or the clamp extension 46 being in the closed position, and a second position, corresponding with one or more of the arm 24 of the base 22 or the clamp extension 46 being in the open position. When the handle 58 is in the first position, the arm 24, the clamp extension 46, and the product to be checked, if present, are locked in place such that undesired movement is not permitted and all necessary checks can be performed on the product. When the handle 58 is moved to the second position, the product is able to be placed into the gage assembly 20 or removed from the gage assembly 20. The handle 58 and the angle between the handle 58 and the clamp extension 46 allows for easy movement between the two positions by a user. The handle 58 may also have a rubber exterior to prevent wear and to provide comfort for the user. In some examples the exterior of the handle 58 may include at least one protrusion circumferentially disposed about the handle 58. In the example shown in FIG. 1, the exterior of the handle 58 has a plurality of protrusions extending along its length. However, various other configurations and amount of protrusions have been contemplated. Additionally, the exterior of the handle 58 may include an identifying color such as red or orange to identify the gage assembly 20 as a component of safety and quality equipment.

In one example, the handle 58, the clamp extension 46 and the tap 42 comprise a manual vertical clamp, such as a manual toggle vertical clamp from Brauer®, however, various other clamp configurations of clamps have been contemplated including but not limited to the clamp types described elsewhere herein and/or a manual toggle horizontal clamp, a push-pull toggle clamps, a toggle latch, a toggle hook clamp, a locking clamp, a bull back toggle clamp, swing cam clamps, cam clamps, toggle pliers, automotive location clamps, and the like. In one example, the clamp 40 is a horizontal hold down clamp. In another example, the clamp 40 is a vertical manual toggle clamp. In another example, the clamp 40 is a horizontal manual toggle clamp. In another example, the clamp 40 is a vertical hold down clamp

In one example, the movement of the handle 58 between the first and second position corresponds with only the clamp extension 46 moving between open and closed position, or may correspond with both the clamp extension 46 and the arm 24 of the base 22 moving between an open position and a closed position. Moreover, it is contemplated that the arm 24 of the base 22 may be coupled to other locating or checking components which are further described below, such that movement of the handle 58 between the first and second position corresponds with the clamp extension 46, the arm 24 of the base 22, and one or more locating component moving between a closed position and an open position.

As described above, and as shown in FIGS. 5-8, the base 22 and/or the arm 24 may be coupled to other locators or clamping elements, as desired. In the example shown in FIG. 5, the arm 24 of the base 22 is coupled to a checking feature, such as a template base 60. The template base 60 is designed to clear the surface of the product to be checked and is one checking mechanism that may be used with the gage assembly 20. The checking feature may also or alternatively include one or a combination of a locator, a positioning pin, a feeler, or the like. In one example the template base 60 may include coupling apertures 62, such that fasteners may be disposed through the arm 24 and through the template base 60 to couple the same. The fasteners may be any type, including, but not limited to, screws, nails, nuts, bolts, washers, anchors, and rivets. Additionally, as shown in FIG. 5, the template base 60 may include a checking aperture 64. In the example shown the checking aperture 64 has a position pin 66, also known as a true position stab pin. When the product to be checked is locked in place by the clamp 40, the position pin 66 may be pushed down by a user to determine if a hole in the part is in the right location and within the correct tolerance. If the position pin 66 can be pushed through the hole, then the hole is accurately sized and positioned on part or product, and if the position pin 66 does not fit in the hole of the part, then the hole is not accurately sized or positioned, such that the part or product may need to be discarded or re-worked and re-checked to pass accurately receive the position pin. Once the position pin 66 is disengaged by the user the position pin 66 may be spring biased such that the positon pin automatically returns to the original position. The spring biasing allows the position pin 66 to be completely and quickly removed from the hole, such that the position pin 66 does not get stuck when trying to remove the checked part from the gage assembly 20. Other locators may include feelers, as described further below, which can check surface heights and/or hole sizes by including one side of the feeler being sized at the lower tolerance and an opposite side being sized at the upper tolerance to determine whether the surfaces or holes to be checked are within the correct tolerance.

Referring now to the example shown in FIG. 6, it is contemplated that multiple gage assemblies 20 may work in conjunction with one another to secure a single product to be checked. In the example shown in FIG. 6, two gage assemblies 20 work in conjunction with one another to secure a single product to be checked. However, it is contemplated that one, two, three, four, five, or more gage assemblies 20 may be present for securing and checking a single product.

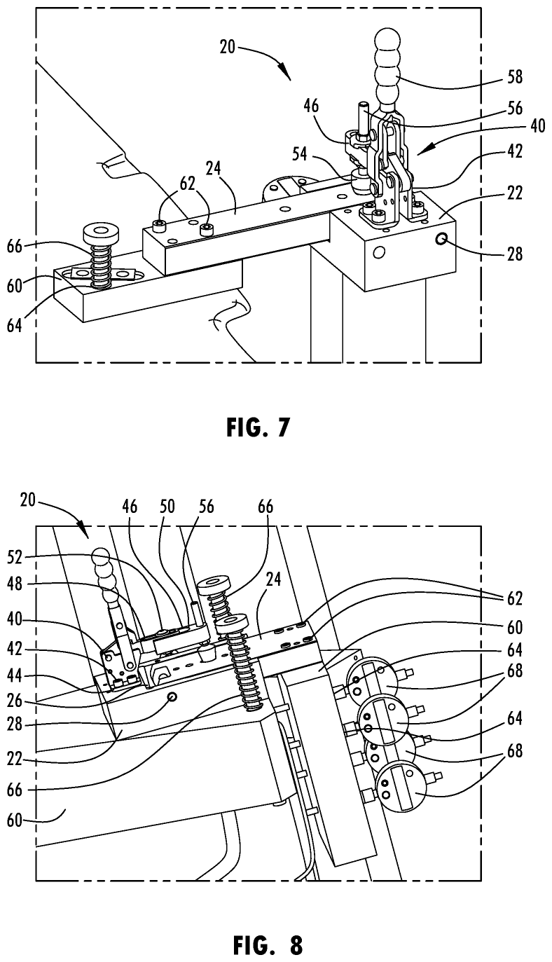

Referring now to the example shown in FIG. 7, the gage assembly 20 has the base 22, arm 24, and clamp 40, which is similar to the base 22, arm 24, and clamp 40 described above; however, the clamp 40 is arranged as a horizontal clamp such that the tap 42 is fixed to the base 22 near the proximal end of the arm 24, but instead of the clamp 40 being in line with the arm 24, the clamp 40 is fixed adjacent to the arm 24 on one side of the recessed portion 26. As such, the clamp extension 46 extends perpendicularly to the arm 24 for the clamp engager 54 to engage and secure the arm 24. Various other base 22, arm 24, and clamp 40 arrangements are described in more detail below.

With respect to the example shown in FIG. 8, it is contemplated that the gage assembly 20 may be coupled to a plurality of template bases 60. In the example shown, the base 22 is coupled to at least one template base which includes fixing apertures and position pins and corresponding apertures. Additionally, the distal end of the arm is coupled to another template base which includes a plurality of no-go/go gages 68 which test a surface to determine whether the surface is in the correct tolerance range. As such, a plurality of template bases 60 and checking features can work in conjunction with a single gage assembly 20.

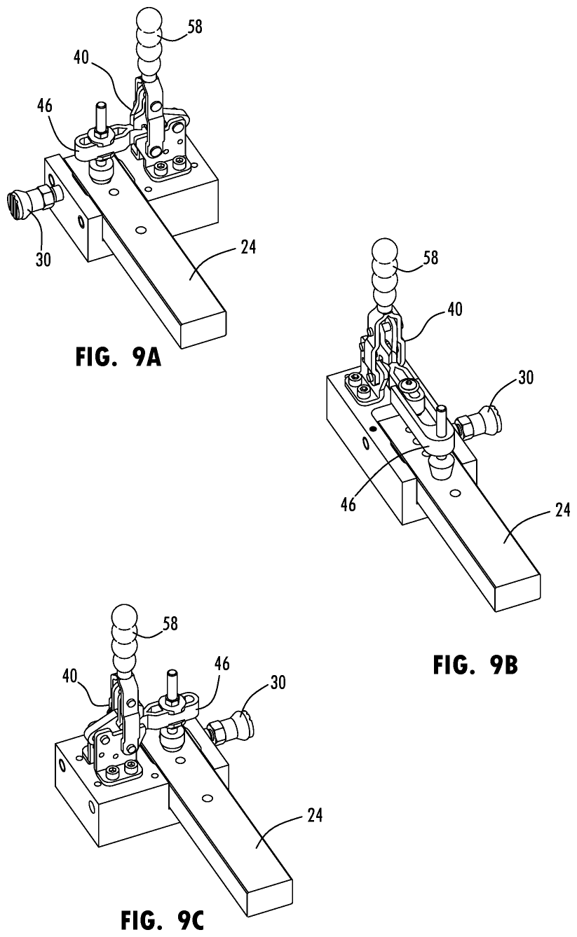

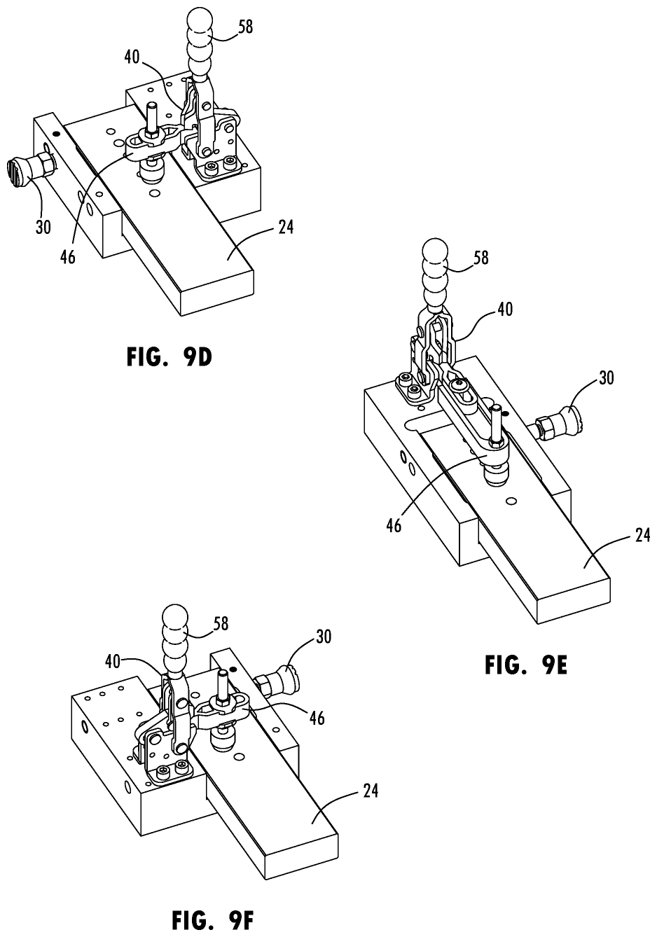

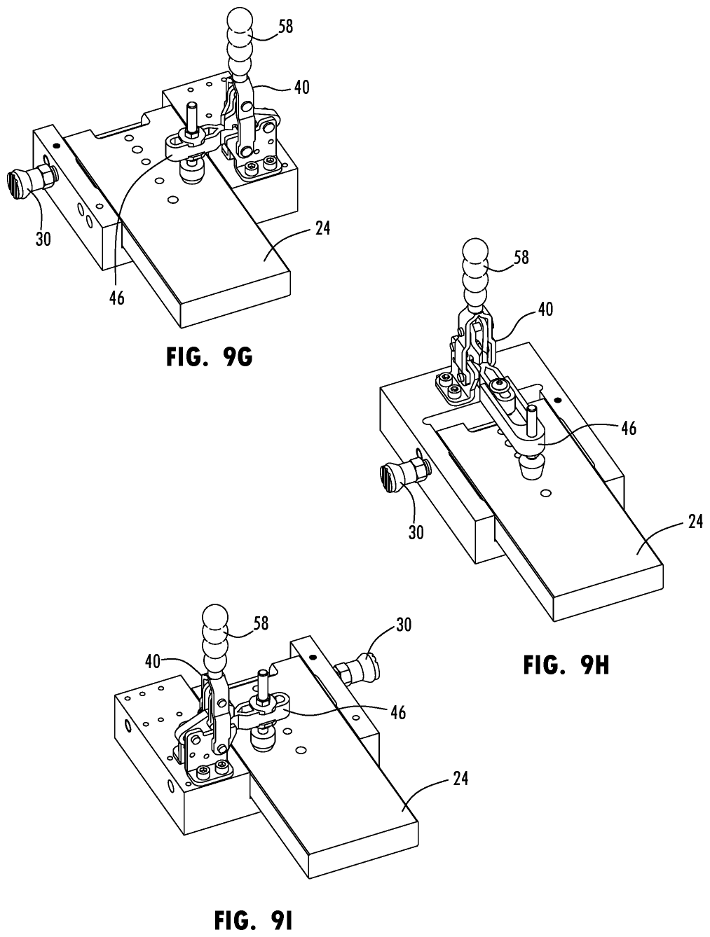

Referring now to the example shown in FIGS. 9A-9I, the base 22, arm 24, and clamp 40 may be of various sizes and shapes and arranged in various ways to accommodate different sizes and shapes of products to be checked. For example, the base 22 in FIG. 9A includes an arm 24 with its distal end extending from the base 22 at a length beyond the recessed portion 26 of the base 22, providing a longer arm 24. Additionally, as shown in the example illustrated in FIG. 9A, the tap of the clamp 40 is a horizontal clamp is disposed on a right side of the base 22 from the arm 24, instead of adjacent the proximal end as shown in previous figures and as described above. The handle 58 is then moved from the first position to the second position in a direction perpendicular to the extension of the arm 24 from the proximal end to the distal end. Additionally, the right side of the base 22, which includes the tap, has a wider surface that the opposite side, which does not include the tap, such that the recessed portion in is offset and the base 22 is not symmetrical. Referring now to the example shown in FIG. 9B, while the clamp 40 is fixed similarly as described above with respect to the example shown in FIGS. 1-8, the arm 24 includes a longer length, such as as shown in FIG. 9A. Also, as shown in FIG. 9C, the base 22 is generally a mirror image of the base 22 shown in FIG. 9A, such that it includes the longer arm 24 as described above, however, the tap of the horizontal clamp is coupled to the base 22 on the left side, such that the left side of the base 22 has a wider surface on the asymmetrical base 22.

Referring now to the examples shown in FIGS. 9D-9F, which are similar to the bases 22 described with respect to FIGS. 9A-9C, respectively, however, the arm 24 is shorter than the arm 24 in the examples shown in FIGS. 9A-9C and the arm 24 has a wider lateral width. As such, when the tap is coupled to one side of the base, the side which is coupled to the tap (i.e. the right side in FIG. 9D and the left side in FIG. 9F) has a similar lateral width as the width of the arm 24. Finally, with respect to the examples shown in FIGS. 9G-9I, which are again similar to the bases 22 described with respect to FIGS. 9A-9C, respectively, however, the arm 24 is even shorter and wider than the arms 24 described with respect to FIGS. 9D-9F. It is also contemplated that various other length and width combinations of bases 22 have been considered as the size and shape of the base 22 and arm 24 is customizable depending on the size and shape of the part or product to be checked and the number of other gage assemblies on the fixture. Moreover, the position of the clamp 40 relative to the arm 24 and base 22 is also customizable depending on the size and shape of the part or product to be checked.

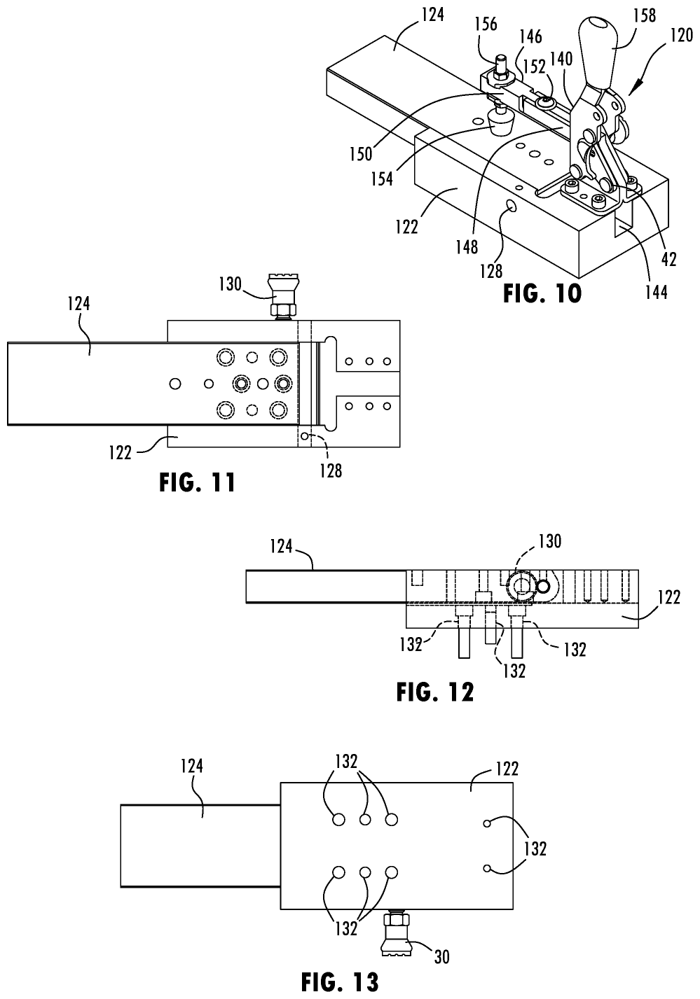

Referring now to the example shown in FIGS. 10-13, the gage assembly 20 may be similar as described above with respect to the example shown in FIGS. 1-8, including but not limited to the base 22 and movable arm 24 and clamp 40 features as described above. However, in the example shown in FIGS. 10-14, the clamp 40, the handle 58, the clamp extension 46, and the tap portion 42 comprise a manual vertical clamp such as a manual hold down vertical clamp from Destaco®; however, various other configurations of clamps 40 have been contemplated including but not limited to those listed above with respect to FIGS. 1-8, a horizontal manual hold down clamp, manual swing clamps, manual latch clamps, pull-action latch clamps, straight line action clamps, variable stoke clamps, squeeze action clamps and the like. Moreover, it is also contemplated that any of the base 22 configurations described in FIGS. 9A-9I could include the clamp 40 as shown in FIGS. 10-14 instead. Additionally, various other base 22, arm 24, and clamp 40 configurations have been contemplated including but not limited to the addition of multiple clamps 40 on a single base 22.

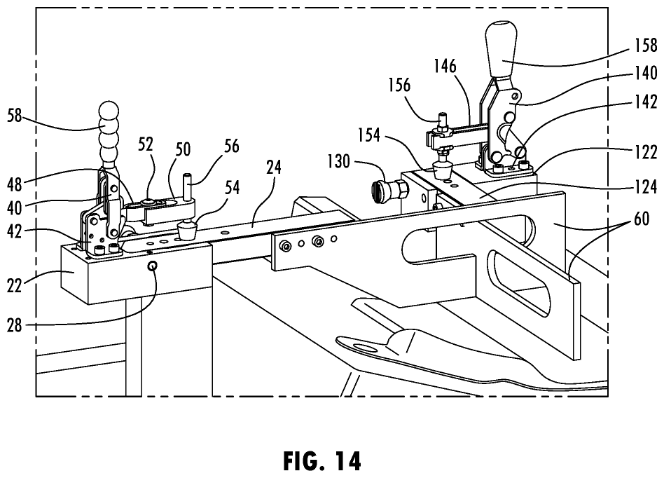

Referring now to the example shown in FIG. 14, a single product may be checked by a combination or different gage assemblies, such as the a gage assembly 20 as described above with respect to FIGS. 1-4 and a gage assembly 120 as described above with respect to FIGS. 10-13. Further, multiple gage assemblies 20 may work in conjunction with a single or multiple gage assemblies 120 to check a single product, as desired.

In one example, the base 22 does not include an arm 24 and the movement of the handle 58 between the first position and the second position corresponds with only the clamp extension 46 moving between the closed position and the open position in conjunction with movement of the handle 58. Additionally, various other locating or clamping components may also be coupled the base 22 which may move in conjunction with the clamp extension 46 and/or may remain fixed to the base 22 as desired.

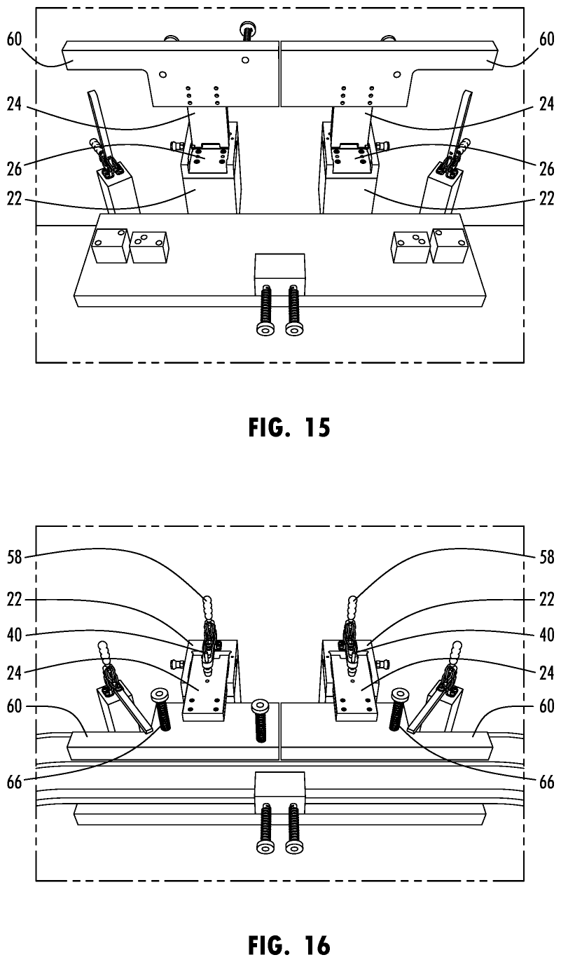

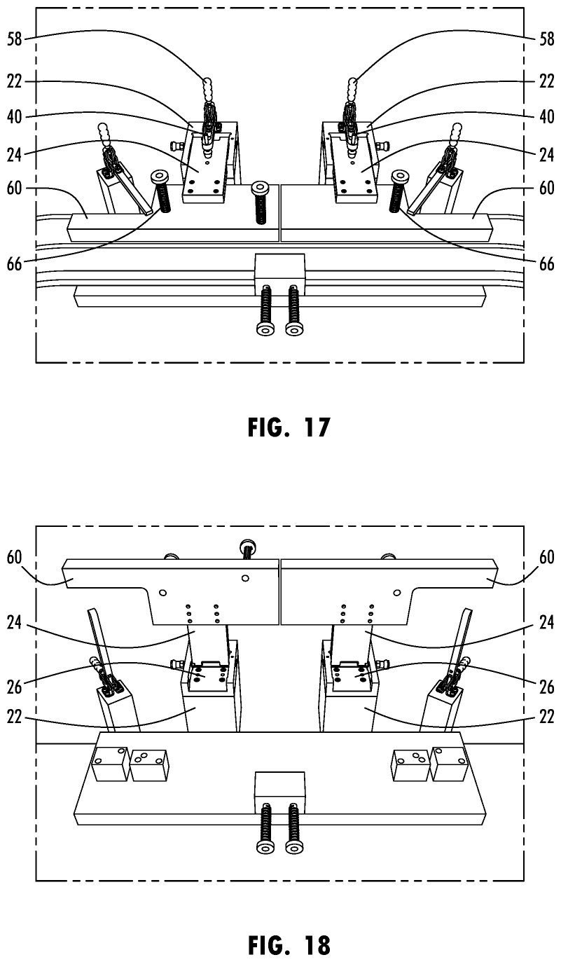

In operation, referring to FIGS. 15-18, first the user engages the handle 58 and pulls the handle 58 from the first position to the second position which in turn moves the clamp extension 46 from the closed position to the open position and the arm 24 from the closed position to the open position (see FIG. 15). Once the arm 24 including the template base 60 is in the open position, the product to be checked can be placed on the locators or otherwise in the desired position to be checked. Once the product to be checked is in the desired position, the user engages the handle 58 and moves the handle 58 from the second position to the first position which in turn moves the clamp extension 46 from the open position to the closed position and the arm 24 from the open position to the closed position. Moving the handle 58 back to the second position engages the clamp engager 54 disposed at the end of the clamp extension 46 with the product to be checked securing the part in place, as shown in FIG. 16. Once the product to be checked is secure, any checks can be completed such as a position pin as described above, or a surface feeler check which a user checks whether the surface of the part is within the correct tolerances with a surface feeler tool, as shown in FIG. 17. Once the desired checks are completed the user may engage the handle 58 and pull the handle 58 from the first position to the second position which in turn moves the clamp extension 46 from the closed position to the open position and the arm 24 from the closed position to the open position. Once the arm 24 is in the open position, the product that was checked can be removed from the locators or otherwise removed from the gage assembly 20. Another product to be checked may then be placed in the locator or in the desired position to be checked and the process can be repeated as needed. Once checking is completed, the user may move the handle 58 back to the first position which in turn moves the clamp extension 46 from the open position to the closed position and the arm 24 including the template base from the open position to the closed position until the gage assembly 20 is needed again.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

Furthermore, to the extent that the terms “includes,” “has,” or “having” or variations in form thereof are used in either the detailed description or the claims, such terms are intended to be inclusive in a manner similar to the term “comprising” as “comprising” is interpreted when employed as a transitional word in a claim.

It is also to be understood that the specific devices and processes illustrated in the attached drawings and described in this specification are examples of aspects of the inventive concepts defined in the appended claims. Hence, specific dimensions and other physical characteristics relating to the examples disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A gage assembly comprising:
a base;
an arm movably coupled to the base and movable between an open position and a closed position;
a clamp fixed to the base and comprising:
a handle configured to move between a first position and a second position; and
a clamp extension configured to move between an open position and a closed position in response to movement of the handle between the first position and the second position; and
wherein the clamp extension in the closed position is configured to hold the arm in the closed position.

2. The gage assembly of claim 1, wherein movement of the handle from the first position to the second position corresponds with movement of the clamp extension from the closed position to the open position.

3. The gage assembly of claim 1, wherein movement of the handle from the first position to the second position corresponds with movement of the arm from the closed position to the open position.

4. The gage assembly of claim 1, wherein the arm and the clamp extension are in the closed position when the handle is the first position.

5. The gage assembly of claim 1, wherein when the handle is the second position, the clamp extension is in the open position and the arm is capable of moving to the open position.

6. The gage assembly of claim 1, wherein movement of the handle toward the second position corresponds with simultaneous movement of the clamp extension toward the open position and movement of the arm toward the open position.

7. The gage assembly of claim 1, wherein the clamp is fixed to the base with a plurality of threaded fasteners that extend into the base.

8. The gage assembly of claim 1, wherein the base comprises a recessed portion that receives the arm in the closed position.

9. The gage assembly of claim 8, wherein the arm is pivotally coupled to the base and configured to rotate partially out of the recessed portion when moving toward the open position.

10. The gage assembly of claim 1, wherein the clamp is one of a vertical hold down clamp, a horizontal hold down clamp, a vertical manual toggle clamp, or a horizontal manual toggle clamp.

11. A gage assembly comprising:
a base having a recessed portion and platform portion;
an arm at least partially disposed in the recessed portion of the base and movable relative to the base between an open position and a closed position;
a clamp fixed to the platform portion of the base and comprising:
a handle configured to move between a first position and a second position; and
a clamp extension configured to move between an open position and a closed position in response to movement of the handle between the first position and the second position; and
wherein the clamp extension in the closed position is configured to contact and hold the arm in the closed position.

12. The gage assembly of claim 11, wherein a distal end of the clamp extension comprises a clamp engager with a flexible portion configured to engage the arm.

13. The gage assembly of claim 11, wherein movement of the handle from the first position to the second position simultaneously moves the clamp extension from the closed position to the open position.

14. The gage assembly of claim 11, wherein when the handle is the first position, the arm and the clamp extension are in the closed position, and wherein when the handle is the second position, the clamp extension is in the open position and the arm is capable of moving to the open position.

15. The gage assembly of claim 11, wherein the clamp is fixed to the base with a plurality of threaded fasteners that extend into the platform portion of the base.

16. The gage assembly of claim 11, wherein the arm is pivotally coupled to the base and configured to rotate partially out of the recessed portion when moving toward the open position.

17. The gage assembly of claim 16, wherein the recessed portion comprises a channel, and wherein an outer surface of the arm is aligned with surfaces of the base on opposing sides of the channel when the arm is in the closed position.

18. The gage assembly of claim 16, wherein the clamp extension has an adjustable length.

19. A gage assembly comprising:
a base having a recessed portion and platform portion;
an arm having a proximal end coupled to the recessed portion of the base with a pin and rotatable about the pin relative to the base between an open position and a closed position;
a checking feature coupled to the distal end of the arm; and
a clamp having a tap portion fixed to the platform portion of the base and a clamp extension movable relative to the tap portion between an open position and a closed position, wherein the clamp extension in the closed position is configured to contact and hold the arm in the closed position for the checking feature to check a product.

20. The gage assembly of claim 18, wherein the clamp comprises a handle that operates to move the clamp extension from the closed position to the open position, and wherein the arm is capable of moving to the open position for removing the product when the clamp extension is in the open position.
